(19) United States
(12) Patent Application Publication
(10) Pub. No.: US 2026/0307210 A1
(43) Pub. Date: Oct. 8, 2026

(54) MOLD, FORMING METHOD AND RELATED ABRASIVE WHEEL

(71) Applicant: INDUSTRIA ABRASIVI PARMENSE - GLOBE SOCIETA' A RESPONSABILITA' LIMITATA, PARMA (IT)

(72) Inventor: Giovanni FICAI, SALA BAGANZA (PR) (IT)

(21) Appl. No.: 19/634,320

(22) Filed: Mar. 31, 2026

(30) Foreign Application Priority Data
Apr. 4, 2025 (IT) 102025000007332

(51) Int. Cl. B24D 5/04; B24D 18/00

(52) U.S. Cl. CPC B24D 5/04; B24D 18/0009; B24D 18/0054

(57) ABSTRACT

An abrasive wheel including a disc-shaped body and at least one annular reinforcing mesh at least partially embedded in the mixture. The disc-shaped body has a central axis and is provided with two opposing faces, each face including protrusions in relief integrally formed with the disc-shaped body and having a predominantly radial development. The protrusions of each face are spaced apart by grooves configured to receive and expel cutting residues from the face of the abrasive wheel responsive to the centrifugal force created by the rotation of the abrasive wheel during a cutting operation. Each protrusion on one face is shaped to be entirely contained within the perimeter of a respective groove on the opposite face. The protrusions on one face are perfectly axially aligned with the grooves on the opposite face. Each protrusion comprises lateral flanks with a curvilinear longitudinal development, preferably following a respective monotonic convex curve.

### TECHNICAL FIELD

The invention relates to a forming mold and a manufacturing method for abrasive wheels, as well as to an abrasive wheel itself, specifically an abrasive wheel having a disc-shaped body obtained by pressing a mixture of abrasive grains mixed with a binder and optionally filler materials. In particular, the invention concerns a forming mold configured to produce abrasive wheels with protrusions (ribs) on at least one of their faces, a method for pressing such abrasive wheels, and the resulting abrasive wheels which exhibit improved cutting performance, reduced lateral friction, and optimized durability. The invention is particularly, but not exclusively, applicable in the field of thin abrasive cutting and/or grinding wheels (with a thickness ranging between 0.5 mm and 10 mm).

### BACKGROUND ART

In the field of abrasive wheels, the production of thin wheels with arcuate, radial, and symmetrical protrusions on their main faces is known. These protrusions are typically obtained using rubberized molds, i.e., molds in which cavities are formed in the steel forming molds and subsequently filled with vulcanized rubber of a specific hardness (“Shore” hardness). During mold preparation, any excess rubber extruding from the cavities is removed by surface grinding the steel discs to achieve a flat and smooth surface.

During the pressing phase, the rubber ribs are compressed due to the high pressures applied by the press and form slightly raised areas compared to the surrounding regions. However, with such known rubberized molds, the ribs formed on the wheel face are almost non-existent and do not offer any real advantage in terms of metal penetration or significant improvements in cooling or cutting efficiency.

Another drawback is that the presence and arrangement of such ribs on both wheel faces create regions within the wheel body that are pressed at different densities. Once fired, this results in varying hardness across the wheel, which leads to bouncing and vibrations during cutting operations, discomfort for the operator's hands, inaccuracies in the cut, and reduced performance.

There is a clear need in the field to overcome these limitations and produce abrasive wheels with superior performance that do not cause bouncing or vibrations during cutting, ensuring operator comfort and accurate cutting. Additionally, it is important that the wheel exhibits a constant density at every point to achieve uniform and consistent performance.

The invention aims to satisfy these and other needs of the prior art through a simple, rational, and cost-effective solution.

In particular, the invention seeks to overcome the issues of conventional abrasive wheels, namely:
a) Low effectiveness of superficial protrusions, which often do not sufficiently emerge from the surface and fail to improve air ventilation, penetration, and cutting efficiency;
b) Undesired density variations in the wheel due to suboptimal cavity design in the pressing molds, which may cause vibrations, cutting inaccuracies, and operator discomfort;
c) Damage to reinforcement meshes during pressing, which compromises the wheel's structural integrity during use.

These aims are achieved through the features set out in the independent claims. The dependent claims define preferred and/or particularly advantageous embodiments of the invention.

### SUMMARY OF THE INVENTION

The present invention relates to an improved abrasive wheel and a corresponding forming mold, as well as a method for its production.

### Abrasive Wheel

In particular, the invention relates to an abrasive wheel obtained by pressing a mixture of abrasive grains and binder, which includes a plurality of protrusions in relief on its faces. The invention described here proposes an innovative solution to overcome these issues through an optimized geometric configuration of the protrusions on the faces of the abrasive wheel.

These protrusions are configured to optimize the cutting process, improving penetration into the material to be cut, expulsion of debris, stability during use, and ventilation and cooling.

The invention makes available an abrasive wheel comprising a disc-shaped body obtained by pressing a mixture of abrasive material grains mixed with a hardened and/or polymerized binder and at least one annular reinforcing mesh embedded (or partially embedded) in the mixture or adhered to one of its faces. The disc-shaped body has a central axis and is provided with two opposing faces, each comprising a plurality of protrusions (or ribs) in relief integrally formed with the disc-shaped body and having a predominantly radial development. The protrusions on each face are spaced apart by grooves configured to receive and expel cutting debris from the face of the abrasive wheel in response to the centrifugal force created by the rotation of said abrasive wheel during a cutting operation. Each protrusion on one face has a shape that can be entirely contained within the perimeter of a respective groove on the opposite face, where the protrusions on one face are perfectly axially aligned with the grooves on the opposite face, and each protrusion includes lateral flanks with a curvilinear longitudinal development, preferably following a respective monotonic convex curve.

In practice, the abrasive wheel comprises a pressed disc-shaped body with a plurality of protrusions in relief, distributed on the two faces and developed predominantly in the radial direction. Thanks to this configuration, there is an improvement in the penetration of the material to be cut, the removal of debris, and the ventilation of the cutting area, reducing overheating.

Furthermore, the abrasive wheel thus formed presents a high consistency of density throughout the entire disc-shaped body, allowing for high hardness of the wheel and reducing the possibility of developing, during cutting, skipping and vibrations of the wheel itself, as well as discomfort to the operator's hands and inaccuracies in cutting due to the density variations present in the wheel body. According to one aspect of the invention, the protrusions on one face have a shape equal to (and mirror) the shape of the grooves on the opposite face. This ensures uniform pressure distribution during pressing, guaranteeing a constant density of the abrasive material.

Moreover, the protrusions on one face can have a shape equal to the shape of the grooves on the same face. This allows for a harmonized arrangement of the grooves and greater structural uniformity.

According to one aspect of the invention, the curvilinear longitudinal development of each lateral flank of any protrusion can be defined by the curve where the tangent at any point of the curve is inclined at an angle less than 90°, preferably less than 70°, more preferably equal to 45°, with respect to the tangent of any concentric circle with the abrasive wheel that passes through said point. This improves the aerodynamics of the centrifugal airflow during use and thus increases ventilation and removal of cutting debris.

Moreover, the studied arrangement and shape of the protrusions ensure perfect overlap between the protrusions on one face and the cavities on the opposite face (and thus the offset of the protrusions without intersections), which allows for the aforementioned possibility of obtaining an abrasive wheel with high consistency of density.

Furthermore, the protrusions can have the same orientation and/or inclination, for example, left-handed on one face (front, namely facing the grinding machine) and right-handed on the opposite face. Thus, it could be said that the tangent to the profile of the protrusions should preferably have an obtuse angle (preferably 135°) with the velocity vector of the abrasive wheel at that point. This improves the stability of the wheel in rotation, avoiding imbalances.

Preferably, these protrusions can extend from a proximal end to the central axis of the abrasive wheel to a distal end from the central axis and proximal to the outer periphery of said abrasive wheel, where preferably the distal end is placed in a more internal position with respect to the outer periphery of the abrasive wheel and, more preferably, presents an edge parallel to the outer periphery of the abrasive wheel and separated from it. In this way, the weakening of the wheel edges is avoided, and greater operational durability is ensured.

For example, each protrusion on each face may have a cross-section of variable width and/or shape, preferably with increasing width from a proximal end to the central axis of the abrasive wheel towards a distal end from the central axis. This allows for optimized control of force distribution during cutting.

Advantageously, each protrusion can emerge from the respective face of the abrasive wheel to a height between 0.01 mm and 1.00 mm, preferably between 0.08 mm and 0.2 mm, ensuring an optimal effect without compromising the mechanical strength of the wheel.

Advantageously, each protrusion can have edges, at least those connecting the protrusion to the respective face, chamfered and/or rounded, thereby reducing the risk of damage to the reinforcing meshes during the pressing phase of the disc and improving the safety of the wheel.

### Forming Mold

For the same purposes mentioned above, the present invention provides a mold that includes forming cavities to create the protrusions of the wheel, arranged in such a way as to achieve perfect alignment of the protrusions and grooves on the two faces. This ensures uniform density of the pressed material. The cavities are preferably left empty (without rubber), allowing for the formation of more pronounced protrusions on the faces of the abrasive wheel, resulting in wheels with improved cutting capabilities.

From an aesthetic point of view, this innovation (with empty cavities, i.e., without rubber) generates protrusions on the face of the wheel that are smooth (and not “orange-peel” like those produced by rubber molds), which are not only more aesthetically pleasing but also technically more efficient.

In detail, the invention provides a forming mold for an abrasive wheel comprising a corresponding annular forming cavity and a forming punch, in which at least one of the annular cavity and the forming punch is provided with a respective annular forming wall, where a plurality of cavities (preferably empty) are recessed in said wall to allow the formation of protrusions on each face of the abrasive wheel during pressing, and the cavities have a predominantly radial development, where the cavities of each wall are spaced apart by (planar) reliefs configured to define respective grooves on the respective face of the abrasive wheel, where each cavity of the forming punch wall has a shape capable of being entirely contained within the perimeter of a respective relief on the opposing wall of the annular cavity, where the cavities of the forming punch wall are perfectly axially aligned with the reliefs of the opposing wall of the forming cavity, and where each cavity includes lateral flanks with a curvilinear longitudinal development, preferably according to a respective monotonic convex curve.

Advantageously, the mold can include positioning means (such as grooves or other objectification means) to maintain precise orientation between the two parts of the mold during pressing, eliminating accidental variations in the density of the wheel.

In particular, the mold can include means to define and/or maintain a predetermined circumferential orientation of the forming punch wall with respect to the forming cavity wall.

Furthermore, the cavities on one wall can have a shape equal to (and mirror) the shape of the recesses on the opposing wall.

Advantageously, the cavities on one wall can have a shape equal to the shape of the recesses on the same wall.

Preferably, the curvilinear longitudinal development of each lateral flank of any cavity can effectively be defined by the curve where the tangent at any point of the curve is inclined at an angle less than 90°, preferably less than 70°, more preferably equal to 45°, with respect to the tangent of any concentric circle with the wall on which the cavity is made that passes through said point.

Preferably, the cavities can have the same orientation and/or inclination.

These cavities can extend from a proximal end to a central axis of the wall in which they are made to a distal end from the central axis and proximal to the external periphery of said wall, where preferably the distal end is placed in a more internal position with respect to the external periphery of the wall and, more preferably, has an edge parallel to the external periphery of the wall and separated from it. Furthermore, each cavity of each wall can have a cross-section of variable width and/or shape, preferably with increasing width from a proximal end to a central axis of the respective wall towards a distal end from the central axis.

Advantageously, each cavity has a depth between 0.01 mm and 1.00 mm, preferably between 0.15 mm and 0.20 mm relative to the remaining part of the wall, preferably planar and orthogonal to a central axis of the wall, which defines the reliefs between the cavities.

Thanks to this solution, it is possible to eliminate the use of rubber in the molds, reducing production costs and the complexity of mold maintenance.

Moreover, thanks to this, it is possible to form smoother protrusions on the face(s) of the abrasive wheel that emerge more prominently (compared to known solutions) from the face of the wheel, thereby improving cutting performance and heat dissipation. Additionally, the chamfered edges of the cavities do not damage the reinforcing meshes during pressing.

The cavities (deep as desired, depending on necessity, for example, between 0.01 mm and 1.00 mm, preferably between 0.15 mm and 0.20 mm) allow for the creation of protrusions (ribs) that, even after baking, emerge significantly from the face of the wheel (at a height as desired, depending on necessity corresponding approximately to the cavity of the mold). These ribs are more pronounced compared to those obtained with known rubber molds, ensuring greater rigidity of the wheel; improved cutting speed; easier penetration and reduced overheating thanks to micro-channels formed on the surface (between the protrusions). Furthermore, the cavities can have chamfered and/or rounded edges at least at the edges that connect the cavities to the wall on which the cavities themselves are recessed.

Thanks to this solution, it is possible to protect the reinforcing meshes, thanks to the chamfered or rounded edges, avoiding the possibility of damaging them during the pressing phase.

Since the sharp edges of the cavities could damage the glass reinforcing meshes applied to the sides of cutting wheels, having these edges chamfered and/or rounded avoids and/or reduces the possibility of causing damage to the reinforcing meshes during pressing.

### Forming Method

The invention, for the same purposes mentioned above, provides a forming method for pressing an abrasive wheel that comprises the following steps:
Preparing a mixture of abrasive material grains and binder;
Preparing at least one annular reinforcing mesh;
Introducing the mixture and at least one annular reinforcing mesh into an annular cavity of a forming mold according to any of the preceding claims; in abrasive wheels (cutting), preferably the reinforcing meshes are placed on the outer faces, but it is not excluded that some abrasive wheels (cutting) may also have one (sometimes only that) internal mesh placed halfway through the thickness of the abrasive wheel.
Applying pressure to the mixture to obtain an annular body equipped with a plurality of protrusions in relief on both faces, each having a predominantly radial development, where the protrusions on each face are spaced apart by grooves, where each protrusion on one face has a shape capable of being entirely contained within the perimeter of a respective groove on the opposite face, where the protrusions on one face are perfectly axially aligned with the grooves on the opposite face, and where each protrusion includes lateral flanks with a curvilinear longitudinal development, preferably according to a respective monotonic convex curve.

Advantageously, the method may include baking the annular body formed by the mold, in order to harden and/or polymerize the binder and to obtain an abrasive wheel.

### BRIEF DESCRIPTION OF THE DRAWINGS

Further characteristics and advantages of the invention will become evident from reading the following description provided as an example and not limitative, with the help of the figures illustrated in the attached tables.

FIG. 1 shows an abrasive wheel according to the invention installed on a grinding machine; viewed from the top side of the machine, the wheel normally rotates clockwise.

FIG. 2 is a rear (or lower) isometric view of an abrasive wheel according to the invention.

FIG. 3 is a front (or upper) isometric view of FIG. 2.

FIG. 4a is a front view of FIG. 2.

FIG. 4b is a partial cross-sectional isometric view.

FIG. 5 is a construction diagram of the profile of the protrusions and the spacing between one protrusion and another on a face of the wheel.

FIG. 6a is a front view of an abrasive wheel according to the invention with a smaller number of protrusions compared to that of FIG. 4a.

FIG. 6b is a schematic front view of FIG. 6a highlighting the arrangement of the protrusions on the two opposing faces of the abrasive wheel showing that each protrusion on one face is located in the space created between two protrusions on the opposite face.

FIG. 7a is a front view of an abrasive wheel according to the invention with an intermediate number of protrusions compared to that of FIG. 4a and FIG. 6a.

FIG. 7b is a schematic front view of FIG. 7a highlighting the arrangement of the protrusions on the two opposing faces of the abrasive wheel.

FIG. 8 is another cross-sectional view along the section line B-B of FIG. 4a.

FIG. 9 is a schematic cross-sectional view of a mold for forming abrasive wheels according to the invention.

FIG. 10 is a front elevation view of a forming wall (of a punch and/or a die) of a mold according to the invention of the mold in FIG. 9.

FIG. 11 is an isometric view of a punch and/or a bottom wall of a mold of FIG. 10.

FIG. 12 is a cross-sectional view along the section line C-C of FIG. 10 and the corresponding enlargement.

FIGS. 13a-13b-13c are schematic views of a sequence of forming an abrasive wheel according to the invention.

FIG. 14 is a cross-sectional view of an enlarged detail of a mold according to the invention in a closed configuration.

FIG. 15 is a flow diagram of a method for forming an abrasive wheel (according to the first or second embodiment), according to the invention.

### BEST MODE FOR CARRYING OUT THE INVENTION

### Abrasive Wheel

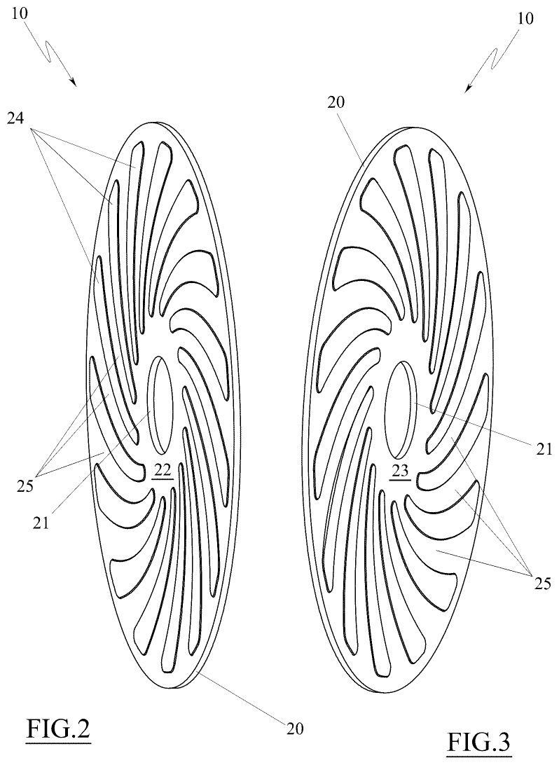

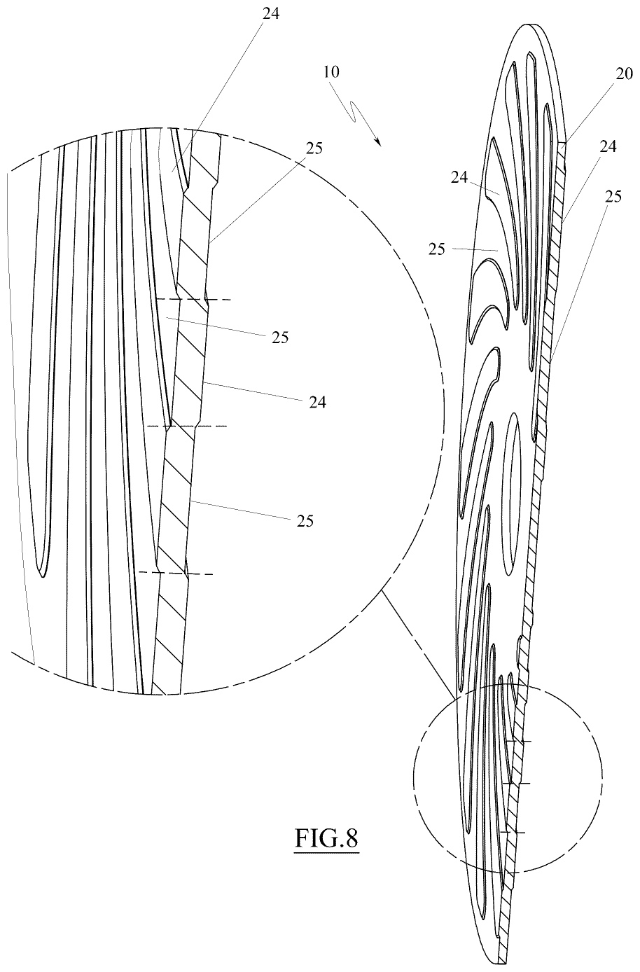

With particular reference to FIGS. 2, 3, 4a, 4b, and 8, the abrasive wheel is generally indicated with 10, for example, a cutting wheel.

It is not excluded that the abrasive wheel could be a deburring or grinding wheel (grinding and/or polishing).

In the illustrated example, the abrasive wheel 10 is a flat (cutting) wheel; however, it is not excluded that it could be of a depressed center type (for cutting or deburring).

The abrasive wheel 10 comprises an annular body 20, equipped with a central axis A, which is, for example, substantially flat (although it is not excluded that the annular body is of a depressed center type).

The annular body 20 is substantially circular and has a central fastening hole 21 coaxial to the annular body 20.

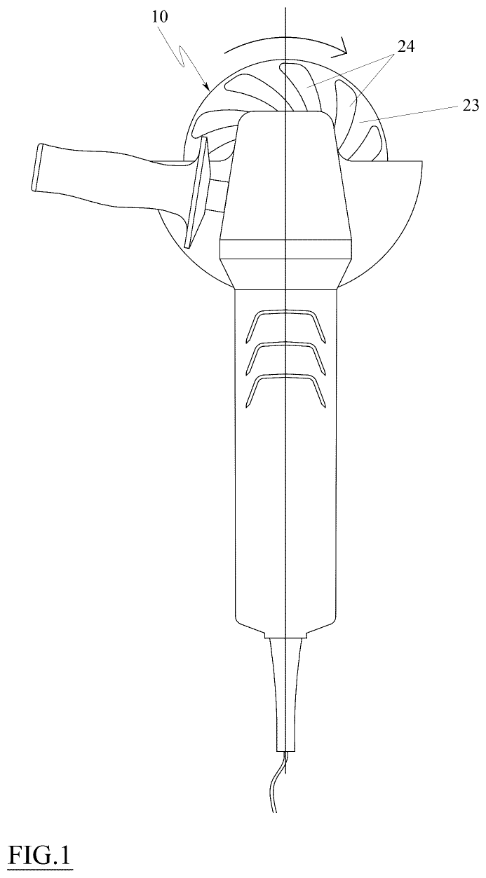

The fastening hole 21 can be connected, substantially coaxially, to the free end of a rotating shaft of a grinding machine (portable or stationary), shown in FIG. 1.

The abrasive wheel 10, or the annular body 20 thereof, can be produced in various sizes to suit different applications. The most common outer diameters include 115 mm, 125 mm, 150 mm, 180 mm, and 230 mm, although smaller and larger diameters are also possible. A characteristic of the abrasive wheel 10 (or the annular body 20) when it is a cutting wheel is its relatively thin thickness, for example, the abrasive wheel 10 (or the annular body 20 thereof) has a thickness close to one-hundredth ( 1/100) of the outer diameter or even less. This does not preclude the invention from being advantageously applicable to wheels of any thickness.

The annular body 20 comprises two opposing faces 22 and 23, with a rear face 22 and an opposing front face 23.

For example, faces 22 and 23 are globally parallel to each other and (for the most part) orthogonal to the central axis A of the abrasive wheel 20.

In general, the rear face 22 is oriented towards the free end of the rotating shaft of the grinding machine when the wheel 20 is fixed to the rotating shaft itself (i.e., the attachment hole 21 is fitted onto it), and the front face 23 is oriented towards the grinding machine.

The annular body 20 has a substantially layered structure and includes at least one or more layers of abrasive mixture.

Each layer of abrasive mixture (once the wheel is pressed and cooked) defines a substantially monolithic body.

For example, each layer of abrasive mixture is made from a mixture of abrasive grains (coated with a binding resin and filler fillers) that is compacted and stably bound by the same binding resin.

In practice, the layer of abrasive mixture is obtained by pressing a mixture of loose abrasive material grains, for example, abrasive material such as natural corundum, sand, quartz, fused artificial corundum, sol-gel or sintered ceramic abrasives, zirconium corundums, silicon carbide, or others, and mixed with an appropriate binder, for example, based on binding resins, such as phenolic resins, liquid and/or in powder and possibly modified with epoxy, phenoxy, rubber, and/or other resins, modified with organic and/or plant or synthetic compounds, and other types of polyimide resins, etc., and/or with additives and fillers.

For example, the amount of resin is between 5% and 40% by weight relative to the weight of the abrasive material grain mixture.

The abrasive material of the abrasive mixture layer has a granulometry substantially between 120 and 12 mesh (the use of abrasive mixtures with larger or smaller granulometry than the reported range is not excluded according to the requirements).

The annular body 20 also includes one or more reinforcing meshes (made of glass fiber or other suitable material such as Kevlar, carbon, basalt, etc.) each substantially embedded or at least partially embedded (if positioned adjacent to the external face of the wheel) in the abrasive mixture layer; there may also be a case where there is only one reinforcing mesh placed in between two layers of abrasive materials, or even the case of a wheel without reinforcing meshes (wheels for low rotation speeds).

In practice, the abrasive mixture layer (or layers of abrasive mixture) surrounds, particularly axially, the entire surface (lower and upper) of the reinforcing mesh.

Each of the faces 22 and 23, i.e., both the front face 23 and the rear face 22, of the annular body 20 of the abrasive wheel 10 includes a motif/design or texturing formed on it.

The motif is obtained during the forming phase of the abrasive wheel 10 (before its final cooking), for example, by means of a specific forming mold that will be described in more detail later. The particular geometry of the reliefs on each face will also be meticulously described later.

Each motif (relief) extends along a circular crown concentric with the annular body 20 and having an outer diameter substantially equal (or slightly smaller) to the outer diameter of the respective face 22 and 23 and, for example, equal (or slightly larger) to the diameter of the fastening hole 21.

Particularly, each of the faces 22 and 23 includes a motif/design or texturing in relief formed on it.

Preferably, the aforementioned motif/design or texturing in relief comprises a plurality of protrusions 24 (in any number as needed) emerging from face 22,23 of the annular body 20 of the abrasive wheel 10.

For example, each protrusion 24 has a height at will, depending on the needs, for example, between 0.01 mm and 1.00 mm, preferably between 0.08 mm and 0.2 mm, (which protrudes from the plane defining face 22,23 from which it rises). This height may reduce slightly during the cooking of the wheel, specifically during the fluid phase of the binding resin, due to the weight of the pile of wheels and the cooking supports, between which each wheel is interposed during the extended cooking phase to maintain the flat (or depressed center) shape. The cooking supports indeed rest on the protrusions and, due to the weight of the pile above, tend to compress them during the fluid phase (between 8° and 130° C.) of polymerization.

Advantageously, each protrusion 24 presents edges, at least those connecting the protrusion 24 to the respective face 22,23, chamfered, for example, by means of an inclined wall at an angle at will, for example, substantially equal to 45° (+) 20°, and/or rounded, for example, by means of a rounded wall (with a rounding radius at will, for example, that can vary between 0.01 and 1 mm).

For example, each protrusion 24 might also present the top edges (distal from those connecting the protrusion 24 to the respective face 22,23) chamfered, for example, by means of an inclined wall at an angle (at will, for example) substantially equal to 45° (+) 20°, and/or rounded, for example, by means of a rounded wall (with a rounding radius at will, for example, that can vary between 0.01 and 1 mm). For example, the lateral wall of each protrusion could be entirely inclined like the aforementioned chamfer or present one or more steps (in which at least one central portion of the step has an inclination orthogonal to the plane of face 22,23 from which it is derived).

Each protrusion 24, for example, presents a substantially planar (and smooth) apical wall parallel to the plane of face 22,23 from which it is derived. Each protrusion 24 preferably presents an elongated shape (along a longitudinal direction, (rectilinear or curvilinear) preferably curvilinear, for example, according to a spiral arc, a circle arc, or an ellipse arc or similar, along a predominant development direction parallel to the plane of face 22,23 on which it is formed. In practice, each protrusion 24 defines a rib.

Furthermore, each protrusion 24 comprises lateral flanks with a curvilinear longitudinal development, preferably according to a respective monotonic convex curve.

Advantageously, the curvilinear longitudinal development of each lateral flank of any protrusion 24 can be defined by a particular geometry of the curve according to which the tangent at any point of the curve is inclined at a constant angle, less than 90°, preferably less than 70°, more preferably less than 60°, and even more preferably equal to 45°+5°, with respect to the tangent of any concentric circle with the abrasive wheel that passes through the said point. This geometry favors the generation of an airflow that channels between one protrusion 24 and another from the innermost zone towards the outermost zone and keeps the cut cool.

A peculiarity that characterizes the invention and improves it compared to similar architectures is that each protrusion 24 of a face 22,23 is located in correspondence with the groove 25 (or cavity) defined between two protrusions 24 of the opposite face 23,22. In this way, the thickness of the annular body 20 and therefore also its density remain constant. A constant density implies a uniform and regular consumption of the disc during its use.

Preferably, it is desired that the protrusions on both faces 22 and 23 of the abrasive wheel 10 have a constant width, measured on a circular arc having its center at the center of the wheel itself; The same value must have the width of the grooves 25 (or spaces) between one protrusion 24 and the adjacent one. In this motion, each face 22,23 of the wheel contains a sequence of equally spaced protrusions 24 with equal width between them and also equal to the width of the grooves 25. The protrusions 24 on the opposite face 23,22 of the wheel will be arranged with an opposite orientation (right-handed if on the first face they are right-handed) and located in correspondence with the grooves 25 present between the protrusions 24 on the first face (to maintain constant thickness). It is therefore obvious that the widths of the grooves 25 and the protrusions 24 are equal to each other and also equal to those of the widths and spaces of the opposite face. Nothing would prevent making the grooves 25 narrower or wider than the protrusions 24; however, if, for example, on one face 22,23 the grooves 25 were narrower than the protrusions 24, the corresponding protrusions 24 on the opposite face would be narrower than the grooves 25 resulting in an unappealing asymmetry in terms of the wheel's aesthetics and that could also lead to distortions in the wheel itself. It is therefore preferred that the width of the protrusions 24 and the grooves 25 on each of the two faces 22,23 remains constant.

The number of protrusions 24 can be chosen at will from any integer value greater than or equal to 2. We will see later that given the number of protrusions “n” the angle between one protrusion 24 and the next is given by a simple mathematical law thus maintaining a constant angular step.

The inclination of the protrusions 24 is determined by the direction of rotation of the abrasive wheel 10 based on the following considerations: an abrasive wheel 10 installed on a grinding machine as in FIG. 1 rotates clockwise; therefore, it is desired that, as seen in the figure, the angle between the tangent to the profile of the protrusion 24 at a point and the velocity vector at that point is obtuse. In other words, the protrusions 24 must have a left-handed longitudinal development. It goes without saying that on the opposite face the protrusions will have a right-handed orientation.

As mentioned, the protrusions 24 on each face 22,23 are spaced apart by grooves 25 configured to generate a centrifugal airflow quite similar to that of a radial turbine. Such a flow helps to keep the cutting surface cool and helps thanks to its motion and the geometry of the grooves 25 to receive and expel the cutting residues from the face of the abrasive wheel 10 in response to the centrifugal force created by the rotation of said abrasive wheel during a cutting operation.

Each protrusion 24 on a face 22,23 has a shape capable of being entirely contained within the perimeter (at least the lateral flanks) of a respective groove 25 on the opposite face.

Advantageously, the protrusions 24 on a face 22,23 have a shape substantially equal to the shape of the grooves 25 on the opposite face 23,22.

Furthermore, the protrusions 24 on a face 22,23 have a shape equal to the shape of the grooves 25 on the same face 22,23.

Advantageously, the protrusions 24 on each face 22,23 extend from a proximal end to the central axis A of the abrasive wheel 10 to a distal end from the central axis A and proximal to the external periphery of said abrasive wheel 10, where preferably the distal end is placed in a more internal position with respect to the external periphery of the abrasive wheel 10 and, more preferably, has a circumferential edge parallel to the external periphery of the abrasive wheel 10 and separated from it.

Moreover, the protrusions 24 as constructed have a cross-section (with respect to their longitudinal development) of variable size and/or shape and increasing from the proximal end towards the distal end.

The (maximum) width of the protrusions 24 (equal among themselves) depends on (and is inversely proportional to) the number of protrusions 24 made on the respective face 22,23.

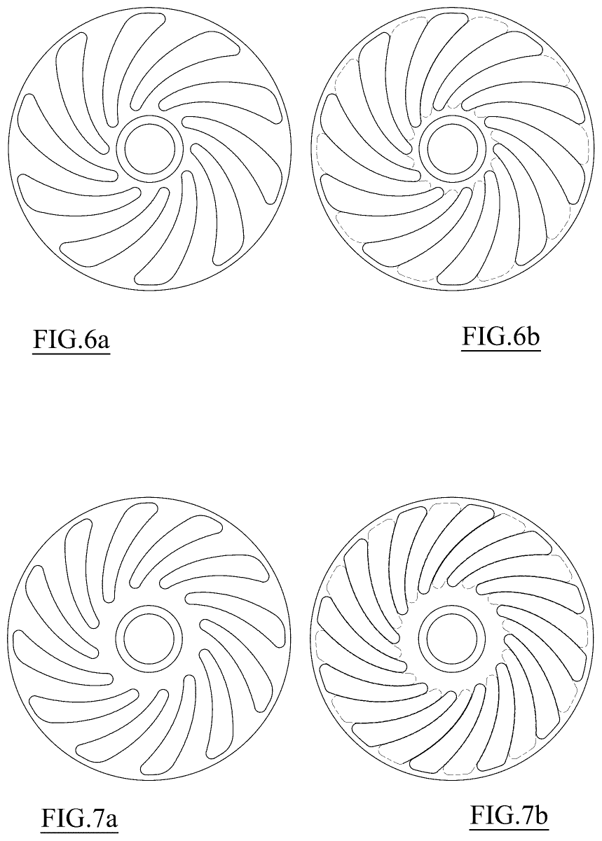

In the example illustrated in FIGS. 6a (and 6b), the number of protrusions 24 for each face 22,23 is equal to no. 10 and in the example illustrated in FIGS. 7a (and 7b), the number of protrusions for each face 22,23 is equal to no. 12, in this second case the protrusions have a maximum width obviously smaller than those of the first case.

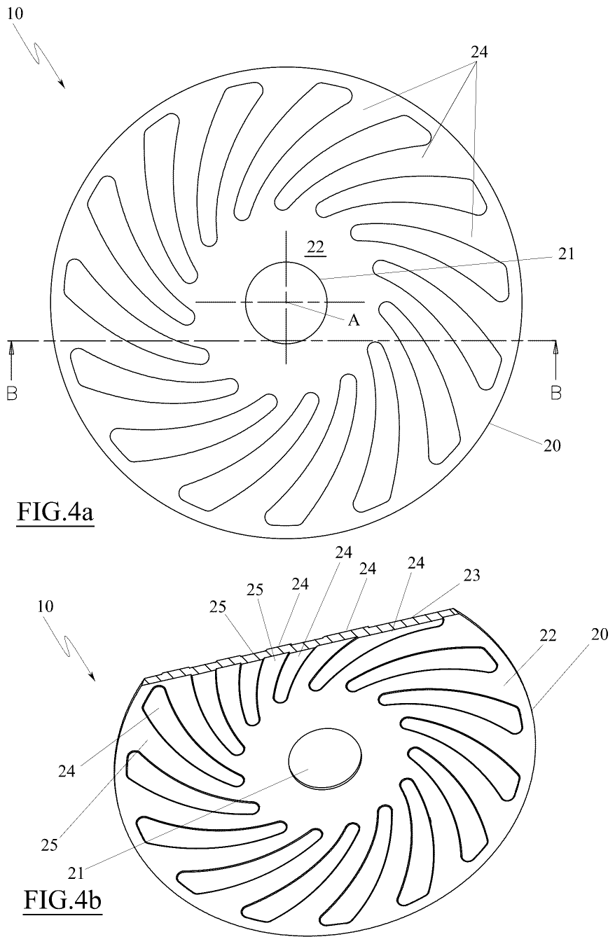

In the example illustrated in FIG. 4a, the number of protrusions for each face 22,23 is equal to no. 15, in this case, the protrusions have a maximum width smaller than those of the first case and the second case mentioned above.

As mentioned, between each pair of adjacent protrusions 24, i.e., in correspondence with each groove 25, evacuation channels are defined for machining chips and/or for aeration/ventilation/cooling of the work area. Particularly, both faces 22 and 23 include a respective (identical) motif/design or texturing in relief formed on them.

The bottom wall of each groove 25 is planar (and perpendicular to the central axis A).

Advantageously, the top wall of each protrusion 24 is (also) planar (and perpendicular to the central axis A, i.e., parallel to the bottom walls of the grooves 25).

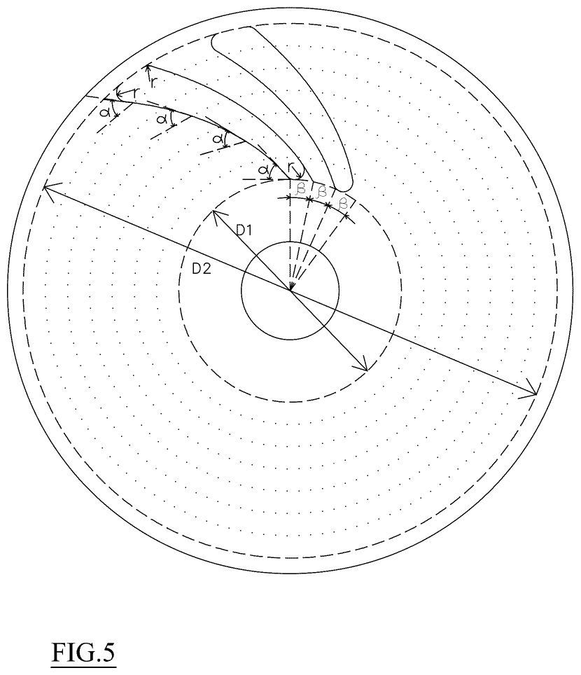

In detail, following the diagram of FIG. 5, the definition of the profiles of the protrusions 24 is obtained through the following geometric procedure: One or each of the lateral flanks of the protrusion 24 (and consequently of the groove 25) is defined by a determined generating line.

In practice, each generating line defines the shape of a lateral flank (inner/intrados or outer/extrados) of a protrusion 24.

The generating line of the protrusion 24 is defined by a spiral line (or curve) whose tangent at each point forms with the concentric circle with the abrasive wheel passing through that point a constant angle α, where for example the angle α is less than 90°, preferably less than 70°, more preferably less than 60°, and even more preferably equal to 45°+5°.

The axial ends of the generating line are determined by two diameters D1 and D2, where:
D1 is the (inner) diameter of a minimum concentric circle with the abrasive wheel 10 that cuts the generating line at its proximal end to the central axis A of the abrasive wheel; and
D2 is the (outer) diameter of a maximum concentric circle with the abrasive wheel 10 that cuts the generating line at its distal end to the central axis A of the abrasive wheel.

In practice, the two circles with diameters D1 and D2 truncate the generating line at their respective axial ends. The diameters D1 and D2 are such that D1 is less than D2, D1 is greater than or equal to (for example, different in the illustrated case) the diameter of the central hole 21 of the abrasive wheel, and D2 is less than or equal to (for example, different in the illustrated case) the outer diameter of the abrasive wheel 10. The choice of diameters D1 and D2, besides technical reasons (where it is advisable to maximize the area covered by the protrusions 24, i.e., it is desirable that the difference between D1 and D2 be as large as possible), is also determined by aesthetic reasons. Additionally, their sizing is related to the external diameter of the specific wheel. In any case, D1 and D2 can be determined as desired according to requirements.

The number n of protrusions 24 to be formed on face 22,23 is a determined value (and variable according to technical, aesthetic, functional, and economic needs). The additional generating line that defines the other lateral flank (outer/extrados or inner/intrados) is generated by rotating through an angle β around the central axis of the abrasive wheel 10, where the angle β is determined (calculated) using the following formula:

$$β = 360 / ( 2 \times n ) ;$$

where n is the number of protrusions 24 to be formed on face 22,23.

All the generating lines (defining the inner lateral flank and the outer lateral flank of each protrusion 24 of face 22,23) are determined by rotating the preceding generating line (in the direction of rotation) by an angle 2×β mentioned above. Advantageously, the radii of curvature r1, r2, r3, r3 of the connections between the two adjacent generating lines (that define the inner lateral flank and the outer lateral flank of each protrusion 24) and the two circles of diameter D1 and D2 mentioned above are defined. Preferably, the radii of curvature are all equal to a single value r, determined by the diameter of the cutter used to work the mold from which the wheel 10 is obtained. However, it is not excluded that the radii of curvature r1, r2, r3, r4 may differ from each other.

The height E of each protrusion 24 is illustrated in FIG. 14. FIG. 14 shows a section where the protrusions 24 and the grooves 25 realized in the abrasive wheel 10 are clearly visible.

Each protrusion, as described above, will feature edges, at least those connecting the protrusion 24 to the respective face 22,23, chamfered, for example, by means of an inclined wall at an angle γ (see FIG. 14) as desired, for example, substantially equal to 45° (±) 15° or 30° (±) 15°.

In practice, the entire lateral flank (inner or outer) of each protrusion is inclined with respect to the plane of face 22,23 by such an angle γ. This chamfer is functional to prevent damage to the glass fiber yarn of the wheel's reinforcing mesh, thereby avoiding sharp edges that could cut or damage the fibers.

Particularly, the protrusions 24 on any face 22, 23 are perfectly axially aligned with the grooves 25 of the opposite face 23,22.

In practice, the perimeter edges of the protrusions 24 on one face 22,23 are contained within the perimeter edges of respective grooves 25 on the opposite face 23,22.

In other words, the protrusions 24 present on the front face 23 are circumferentially (perfectly) offset from the protrusions 24 present on the rear face 22, for example by half a step or half the pitch between the cavities 54 of the same wall 51,52. Preferably, the protrusions 24 on each face 22,23 are geometrically constructed in the same way (as described above), but such that the protrusions 24 on one face 22,23 are angularly offset with respect to the protrusions on the opposite face 23,22, for example, precisely by the aforementioned angle β in FIG. 5. In this way, the protrusions 24 on one face 22,23 align exactly with the grooves 25 (between the protrusions 24) on the opposite face 23,22.

Thanks to this, the thickness S of the annular body 20 of the abrasive wheel 10 is substantially constant (throughout its entirety).

Therefore, the density of the material composing the annular body 20 of the abrasive wheel 10 is substantially constant (throughout its entirety), thereby preventing excesses or deficiencies in density that would lead to irregular wear of the wheel itself during use.

The nominal thickness h of the abrasive wheel 10, defined by the maximum distance between the crests of the protrusions 24 on the opposing faces 22,23, is greater than the point thickness S, which determines the (constant) density of the annular body 20 (see FIG. 10).

Moreover, an annular label can be applied to the front face 22 of the annular body 20 of the abrasive wheel 10 (in general), on which the technical details of the abrasive wheel itself are reported, with the label being applied to an annular portion (flat or convex) of the front face 22.

Finally, the abrasive wheel 10 may include one or more metallic annular elements, commonly known as washers or collars, that delimit the fastening hole 21 of the annular body 20 to precisely fit onto the spindle of the grinding machine. The washer is fixed on one of the two faces 22,23 of the annular body 20 and includes a hollow central collar that fits substantially to measure into the fastening hole 21 and has an axial thickness substantially equal (or slightly less) to the axial thickness of the annular body 20. It is not excluded that a second washer could also be fixed on the other face of the abrasive wheel 10.

### Forming Mold

The abrasive wheel 10 is obtained by pressing, for example, using a forming mold 50 and a forming method as described below.

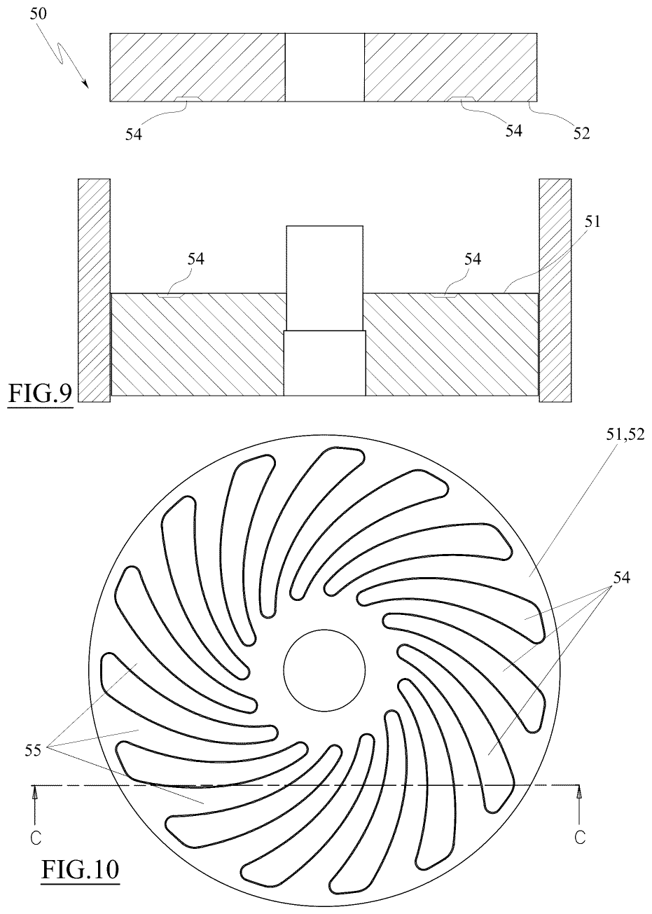

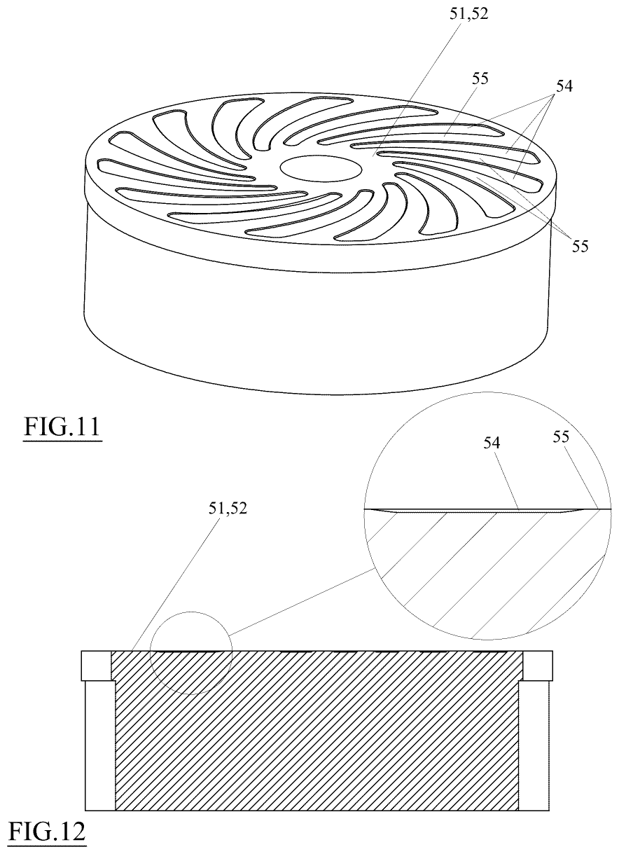

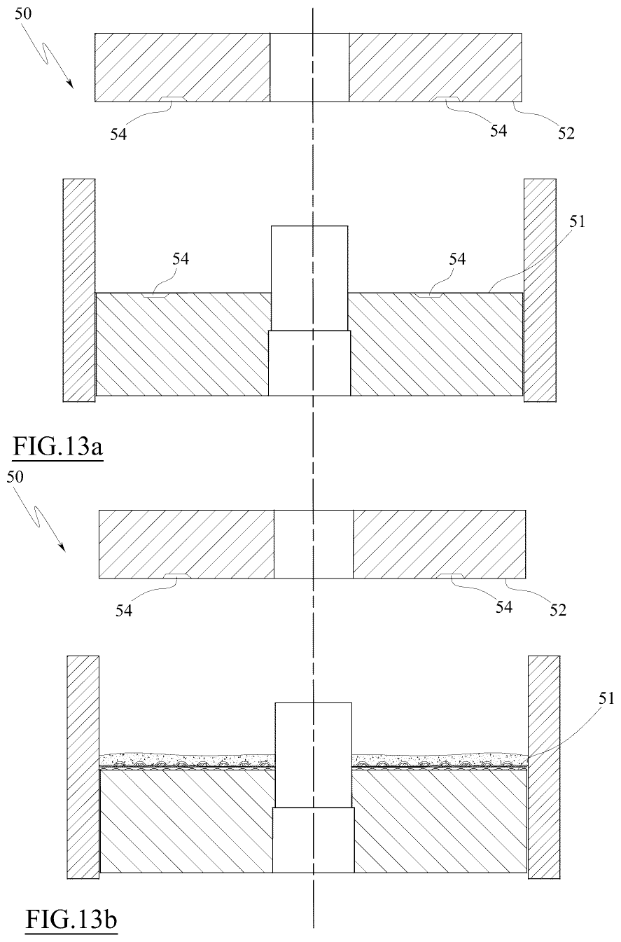

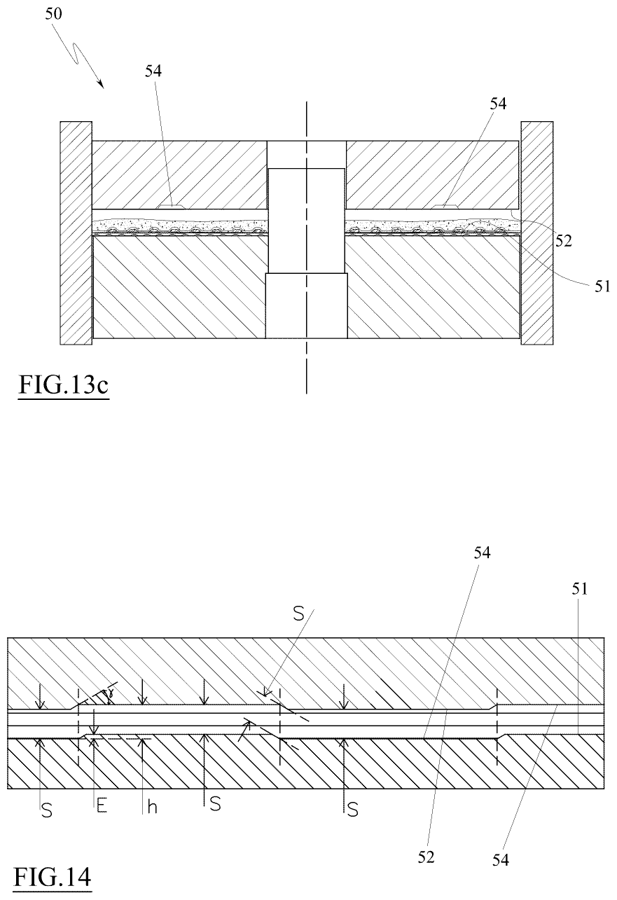

By way of example, the forming mold (see FIGS. 9-10, 11-12-13) for abrasive wheels 10 comprises a mold matrix designed to oppose a punch for forming the abrasive wheel 10.

The matrix, for example, includes a cylindrical jacket (commonly called a ring), which is closed at the bottom by a bottom wall 51, defining an annular forming face of the mold 50.

In practice, the bottom wall 51 comprises a disk-shaped body with a circumferential base and is, for example, made of metallic material suitable for being inserted substantially to measure within the cylindrical jacket.

The bottom wall 51 and the cylindrical jacket define an open-top forming chamber. Advantageously, the bottom wall 51 can be associated slidably with respect to the cylindrical jacket to vary the internal volume of the forming chamber, practically varying the axial position of the bottom wall relative to the cylindrical jacket. This is useful, for example, for loading loose abrasive material into the mold (to create an abrasive layer of constant thickness by trimming the excess with a blade) and for extracting the pressed wheel.

The bottom wall 51 has a centering pin protruding from its upper face and coaxial with the cylindrical jacket.

The centering pin, in particular, is inserted into a central hole made in the bottom wall and fixed there or floating.

The forming chamber with the centering pin protruding from the bottom wall 51 defines an (open) annular cavity for forming the annular body 20 of the abrasive wheel 10.

The upper face of the bottom wall 51 can be substantially planar if a flat abrasive wheel 10 is to be made, while it can have a central recess if depressed center wheels are to be molded.

In any case, the bottom wall defines a support plane for the abrasive wheel 10 to be formed, substantially orthogonal to the axis of the cylindrical jacket. The punch, for example, comprises an annular/disk-shaped body whose external diameter is substantially equal to the external diameter of the bottom wall of the mold matrix (or slightly smaller than the internal diameter of the cylindrical jacket), so that it can be inserted substantially to measure within the cylindrical jacket and superimposed on the bottom wall itself.

The punch, therefore, comprises a lower annular/circular wall 52, which defines an annular forming face opposed (and parallel) to the annular forming face defined by the bottom wall 51.

If a depressed center abrasive wheel 10 is to be formed, the punch includes a central (convex) shape complementary to the bottom wall.

The punch and the bottom wall are movable in reciprocal approach/separation, respectively for the closing/opening of the forming chamber, as is known to a technician in the field, for pressing the abrasive wheel 10.

At least one of the lower wall 52 of the punch and the bottom wall 51 of the mold matrix 50, or only one of them or each of them, includes a (respective) motif/design or texturing, complementary to that to be formed on the respective face 22,23 of the abrasive wheel 10, formed on it.

Particularly, each of the walls 51,52, i.e., the lower wall 52 of the punch and the bottom wall 51 of the matrix, includes a complementary motif/design or texturing formed on it.

Preferably, the aforementioned motif/design or complementary texturing includes a plurality of cavities 54, which are recessed into the respective wall 51,52 (according to a predetermined design), which in the remaining part is, for example, globally flat.

For example, each cavity 54 has a depth between 0.01 mm and 1.00 mm (relative to the plane defining the lower wall 52 from which it derives), preferably between 0.15 mm and 0.20 mm.

Advantageously, each cavity 54 has edges, at least those joining the cavity 54 to the respective wall (i.e., the lower wall 52), chamfered, for example, by means of an inclined wall at an angle γ as desired, for example, substantially equal to 45° (±15°) 30° (±15°), and/or rounded, for example, by means of a rounded lateral wall (with a rounding radius as desired, for example, that can vary between 0.01 and 1 mm).

For example, each cavity 54 might also have chamfered top edges (distal from those connecting the protrusion 54 to the respective wall, i.e., the lower wall 52), for example, by means of an inclined wall at an angle as desired, for example, substantially equal to 45° (±15°), and/or rounded, for example, by means of a rounded wall (with a rounding radius as desired, for example, that can vary between 0.01 and 1 mm).

The base of each cavity 54 is, for example, planar and parallel to the plane of the wall (i.e., the lower wall 52) in which it is recessed.

For example, the lateral wall of each cavity 54 could be entirely inclined like the aforementioned chamfer or present one or more steps (in which at least one central portion of the step has an inclination orthogonal to the plane of the wall, i.e., the lower wall 52, from which it derives).

Each cavity 54 preferably presents an elongated shape (along a longitudinal direction, rectilinear or curvilinear) preferably curvilinear, for example, according to a circle arc, spiral, or ellipse arc or similar, along a predominant development direction parallel to the plane of the wall (i.e., the lower wall 52) on which it is recessed.

Furthermore, each cavity 54 includes lateral flanks with a curvilinear longitudinal development, preferably according to a respective monotonic convex curve.

Advantageously, the curvilinear longitudinal development of each lateral flank of any cavity 54 is defined by the curve according to which the tangent at any point of the curve is inclined at an angle less than 90°, preferably less than 70°, more preferably less than 60°, and even more preferably equal to 45°+5°, relative to the tangent to the concentric circle with the respective wall 51,52 that passes through the said point.

The inclination of the cavities 54 is, for example, right-handed on one wall (and left-handed on the opposite wall).

The cavities 54 are substantially parallel to each other and, preferably, equidistant (i.e., with a constant angular pitch).

The cavities 54 on each wall 51,52 are spaced apart by reliefs 55 of the respective wall 51,52, where such reliefs are preferably planar, coplanar, and orthogonal to the central axis of the mold 50.

Each cavity 54 on a wall 51,52 (of the matrix or the punch) has a shape capable of being entirely contained within the perimeter (at least the lateral flanks) of a respective relief 55 on the opposing wall 52,51 (of the punch or the matrix). Advantageously, the cavities 54 on one wall 51,52 (of the matrix or the punch) have a shape substantially equal to the shape of the reliefs 55 on the opposing wall 52,51 (of the punch or the matrix).

Furthermore, the cavities 54 on one wall 51,52 have a shape equal to the shape of the reliefs 55 on the same wall 52,51.

Advantageously, the cavities 54 on each wall 51,52 extend from a proximal end to the central axis of the mold 50 to a distal end from the central axis and proximal to the outer periphery of the wall 51,52, where preferably the distal end is positioned more internally with respect to the outer periphery of the respective wall 51,52 and, more preferably, has a circumferential edge parallel to the outer periphery of the respective wall 51,52 and separated from it.

Furthermore, the cavities 54 have a cross-section (relative to their longitudinal development) of variable size and/or shape, for example, they may have an increasing width from the proximal end towards the distal end from the center. The (maximum) width of the cavities 54 (equal among themselves) depends on (and is inversely proportional to) the number of cavities 54 made on the respective wall 51,52.

Between each pair of adjacent cavities 54, i.e., in correspondence with each relief 55, planar portions of the respective wall 51,52 are defined.

Particularly, both walls 51,52, i.e., both the lower wall 52 of the punch and the bottom wall 51 of the matrix, include a respective (identical) complementary motif/design or texturing formed on them.

The top wall of each relief 55, as mentioned, is planar (and perpendicular to the central axis of the mold 50).

Advantageously, the bottom wall of each cavity 54 is (also) planar (and perpendicular to the central axis of the mold 50, i.e., parallel to the top walls of the reliefs 55).

The geometric definition of the shape of the cavities 54 on the respective wall 51,52 is the same as described above (with reference to FIGS. 14 and 5) for the protrusions 24 on a face 22,23 of the abrasive wheel 10.

Particularly, the cavities 54 on any wall 51,52 are perfectly axially aligned (overlapping the reliefs on the opposing wall 52,51).

In practice, the perimeter edges of the cavities 54 on one wall 51,52 are aligned in plan view and contained within the perimeter edges of respective reliefs 55 on the opposing wall 52,51.

In practice, the cavities 54 present on the lower wall 52 are circumferentially (perfectly) offset from the cavities 54 present on the bottom wall 51, for example, by half a step or half the pitch between the cavities 54 on the same wall 51,52. In practice, each cavity 54 on a wall 51,52 is axially aligned with a relief 55 (or a planar/rectified portion) on the opposing wall 52,51. To maintain this positioning, the upper and lower molds must not be free to rotate relative to each other.

The mold 50, preferably, therefore, includes means to define and/or maintain a (unique) predetermined circumferential orientation of the lower wall 52 of the forming punch relative to the bottom wall 51 of the forming cavity.

For example, such means may include:
an (axial) groove made in one between the cylindrical jacket and the bottom wall 51 and a tongue made in the other between the bottom wall 51 and the cylindrical jacket, so that the bottom wall 51 can be oriented in a single possible orientation relative to the cylindrical jacket; and/or
an (axial) groove made in one between the cylindrical jacket and the punch and a tongue made in the other between the punch and the cylindrical jacket, so that the lower wall 52 of the punch can be oriented in a single possible orientation relative to the cylindrical jacket.

It is not excluded that said means can be realized in another way, for example, magnetic and/or visual (like reference marks), the use of pins fixed on the molds that slide within special holes made in the structure of the press, or vice versa, or anything else, capable of allowing and/or maintaining a unique predetermined circumferential orientation of the lower wall 52 of the forming punch relative to the bottom wall 51 of the matrix, such that the cavities 54 on the two walls 51,52 are perfectly offset, as described above, without axial intersections between them.

### Forming Method

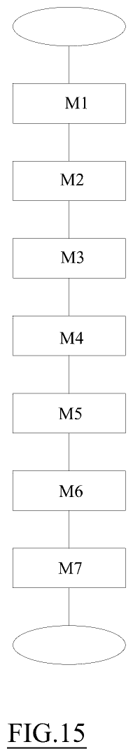

The forming method—of which a schematic flow diagram is illustrated in FIG. 15—provides for the formation by pressing of an abrasive wheel 10 as described above.

The forming method, for example, includes:
Providing a forming mold 50 as described above (block M1); and
preparing (block M2) a mixture of abrasive material grains, binder, and fillers, as known to a technician in the field.

For example, in the setup of the forming mold 50, the tooling phase is provided, which involves—acting on the means to define and/or maintain a (unique) predetermined circumferential orientation of the lower wall 52 of the forming punch with respect to the bottom wall 51 of the forming cavity of the forming mold 50—orienting the bottom wall 51 with respect to the lower wall 52 to define and/or maintain a (unique) predetermined circumferential orientation of the lower wall 52 of the forming punch with respect to the bottom wall 51 of the forming cavity. This (unique) orientation is such that the cavities 54 of one wall 51,52 are perfectly offset, as described above, by half a step, i.e., not at all overlapping the cavities of the opposite wall 52,51.

The forming method, therefore, initially provides, for example, to insert (block M3) into the forming cavity, so that it fits onto the centering pin and rests on the bottom wall 51 (for example, on its peripheral portion), the washer with the hollow central shank protruding from the bottom wall itself.

Subsequently, if provided, the label is placed (block M4) on the bottom wall 51 and/or on the washer.

Subsequently, (block M5) a reinforcing mesh and one or more alternating abrasive mixture layers and/or one or more pre-prepared reinforcing meshes are introduced into the forming cavity, for example, resting on the bottom wall 51 (directly or with the interposition of the label). Generally, as the last component, a reinforcing mesh is introduced resting on the abrasive mixture layer.

In the case of thin cutting wheels, normally, (in addition to the washer and the label) a mesh is placed at the bottom, an abrasive mixture layer, and a mesh resting on the abrasive mixture layer; In this way, the wheel will contain one abrasive mixture layer and two reinforcing meshes positioned externally to the mixture. The meshes that are pre-impregnated with resin (generally phenolic) adhere to the abrasive mixture during the subsequent polymerization phase. When the recipe for the abrasive wheel 10 is completed (i.e., each of the layers intended to compose the abrasive wheel 10 has been composed according to a predetermined formation recipe), the forming method involves bringing the punch closer to the matrix (introducing it coaxially inside the cylindrical jacket, in order to apply pressure (block M6) to the mixture to obtain a compact and solid annular body 20; the abrasive grains coated with resin under strong pressure indeed stick to each other, making the artifact manipulable and prepared for the subsequent polymerization cycle (see further below).

Thanks to the presence of at least one wall 51,52 with the aforementioned cavities 54, a plurality of (complementary) protrusions are formed on one of the faces 22,23 of the annular body 20, where the protrusions have chamfered and/or rounded edges, at least the edges that join the protrusions to face 22,23.

Preferably, respective protrusions are formed on both faces 22,23 (where the protrusions present on one face 22,23 are preferably circumferentially offset with respect to the additional protrusions present on the other face 23,22). In practice, the method involves forming protrusions 24 on both faces 22,23 of the abrasive wheel 10 according to a precise geometric arrangement (using a mold as described above), which, for example, provides that the protrusions 24 are formed in the following way (as described above in relation to FIGS. 14 and 5).

A generating line is determined (which defines one or both lateral flanks of the protrusion 24).

In practice, each generating line defines the shape of a lateral flank (inner/intrados or outer/extrados) of a protrusion 24.

The generating line of the protrusion 24 is defined by a line (or curve) whose tangent at each point forms with the concentric circle with the abrasive wheel passing through that point a constant angle α, where, for example, the angle α is less than 90°, preferably less than 70°, more preferably less than 60°, and even more preferably equal to 45°+5°.

Diameters D1 and D2 are predetermined, where:
D1 is the (internal) diameter of a minimum concentric circle with the abrasive wheel 10 that cuts the generating line at its proximal end to the central axis A of the abrasive wheel; and
D2 is the (external) diameter of a maximum concentric circle with the abrasive wheel 10 that cuts the generating line at its distal end to the central axis A of the abrasive wheel.

In practice, the two circles with diameters D1 and D2 truncate the generating line at their respective axial ends.

The diameters D1 and D2 are such that D1 is less than D2, D1 is greater than or equal to (for example, different in the illustrated case) the diameter of the central hole 21 of the abrasive wheel, and D2 is less than or equal to (for example, different in the illustrated case) the outer diameter of the abrasive wheel 10.

The number n of protrusions 24 to be formed on face 22,23 is determined. The additional generating line that defines the other lateral flank (outer/extrados or inner/intrados) is generated by rotating through an angle β around the central axis of the abrasive wheel 10, where the angle β is determined (calculated) using the following formula:

$$β = 360 / ( 2 \times n ) ;$$

where n is the number of protrusions 24 to be formed on face 22,23.

All generating lines (defining the inner lateral flank and the outer lateral flank of each protrusion 24 of face 22,23) are determined by rotating the preceding generating line (in the direction of rotation) by the same angle β mentioned above. Advantageously, the radii of curvature r1, r2, r3, r3 of the connections between the two adjacent generating lines (that define the inner lateral flank and the outer lateral flank of each protrusion 24) and the two circles of diameter D1 and D2 mentioned above are defined. Preferably, and for practicality in making the molds, the radii r1, r2, r3, r3 are all equal to a single value r.

The height E of each protrusion 24 is illustrated in FIG. 14.

Each protrusion, as described above, will feature edges, at least those connecting the protrusion 24 to the respective face 22,23, chamfered, for example, by means of an inclined wall at an angle γ (see FIG. 14) as desired, for example, substantially equal to 45° (±15°) or 30° (±15°).

In practice, the entire lateral flank (inner or outer) of each protrusion is inclined with respect to the plane of face 22,23 by such an angle γ.

Particularly, the protrusions 24 on any face 22,23 are perfectly axially aligned with the grooves 25 on the opposite face 23,22.

For example, the protrusions 24 on each face 22,23 are constructed in the same way (as described above), but such that the protrusions 24 on one face 22,23 are angularly offset with respect to the protrusions on the opposite face 23,22, for example, precisely by the aforementioned angle β.

In this way, the protrusions 24 on one face 22,23 align exactly with the grooves 25 (between the protrusions 24) on the opposite face 23,22.

The arrangement of materials in the mold could also be reversed, in which case the metal washer would be inserted into the mold last.

In any case, the pressure applied to the mixture at this stage is between 10 Kgf/cm² and 1000 Kgf/cm², preferably between 200 Kgf/cm² and 500 Kgf/cm².

In practice, the forming method involves pressing (block M6) the assembly of the various abrasive mixture layers and/or reinforcing mesh(es) that have been previously placed in the forming cavity to obtain the abrasive wheel 10 (raw semi-finished) in the desired shape (flat or depressed center).

Pressing occurs by the mutual approach of the lower wall 52 of the punch and the bottom wall 51 of the matrix (within the cylindrical jacket).

At the end of the pressing phase, the annular body 20 formed by the mold 50 is removed (block M7).

The forming method then provides for subjecting the thus-formed abrasive wheel 10 to a thermal treatment (block M7) of hardening/polymerization (cooking phase), for example, in special polymerization ovens, where the polymerization of the binding resin is completed, which stably solidifies, hardens, and retains the abrasive mixture that constitutes the abrasive wheel itself (or the disc-shaped body that constitutes it); during the thermal treatment, the wheel is preferably (but not necessarily) interposed between two polymerization supports in the shape of a disk generally made of metal to preserve its flat shape. If the wheel has a depressed center, the polymerization supports will have a depressed center shape that mirrors that of the wheel.

In practice, the abrasive wheel 10 is subjected to a thermal cycle that involves inserting it into an oven at a temperature substantially between 70° C. and 220° C. for a time substantially between 1 minute and 100 hours, or it can be baked in situ in the same mold, if it is heated/heatable.

The invention thus conceived is susceptible to numerous modifications and variations all falling within the scope of the inventive concept.

Additionally, all details are replaceable with technically equivalent elements.

In practice, the materials used, as well as the contingent shapes and sizes, can be any according to the needs without departing from the scope of protection of the following claims.

### NUMERICAL REFERENCES

Abrasive wheel 10
Annular body 20
Central axis A
Fastening hole 21
Faces 22,23
Rear face 22
Front face 23
Protrusion(s) 24
Groove(s) 25
Forming mold 50
Wall(s) 51,52
Bottom wall 51
Lower wall 52
Cavity/ies 54
Reliefs 55

1. An abrasive wheel comprising a disc-shaped body obtained by pressing a mixture of abrasive material grains mixed with a cured and/or polymerized binder and at least one annular reinforcing mesh at least partially embedded in the mixture, wherein the disc-shaped body has a central axis and is provided with two opposing faces, each face comprising a plurality of protrusions in relief integrally formed with the disc-shaped body and having a predominantly radial development, wherein the protrusions of each face are spaced apart by grooves configured to receive and expel cutting residues from the face of the abrasive wheel responsive to the centrifugal force created by the rotation of the abrasive wheel during a cutting operation, wherein each protrusion on one face is shaped to be entirely contained within the perimeter of a respective groove on the opposite face, wherein the protrusions on one face are perfectly axially aligned with the grooves on the opposite face, and wherein each protrusion comprises lateral flanks with a curvilinear longitudinal development, preferably following a respective monotonic convex curve.

2. The abrasive wheel according to claim 1, wherein the protrusions on one face have a shape equal to the shape of the grooves on the opposite face.

3. The abrasive wheel according to claim 2, wherein the protrusions on one face have a shape equal to the shape of the grooves on the same face.

4. The abrasive wheel according to claim 1, wherein the curvilinear longitudinal development of each lateral flank of any protrusion is defined by the curve according to which the tangent at any point of the curve is inclined at an angle less than 90°, preferably less than 70°, more preferably equal to 45°, with respect to the tangent of any concentric circle with the abrasive wheel passing through said point.

5. The abrasive wheel according claim 4, wherein the protrusions on one face have the same orientation and/or inclination.

6. The abrasive wheel according to claim 1, wherein said protrusions extend from a proximal end to the central axis of the abrasive wheel to a distal end from the central axis and proximal to the outer periphery of said abrasive wheel, wherein preferably the distal end is positioned more internally with respect to the outer periphery of the abrasive wheel and, more preferably, has a border parallel to the outer periphery of the abrasive wheel and separated from it.

7. The abrasive wheel according to claim 1, wherein each protrusion on each face has a cross-section of variable width and/or shape, preferably with increasing width from a proximal end to the central axis of the abrasive wheel towards a distal end from the central axis.

8. The abrasive wheel according to claim 1, wherein each protrusion emerges from the respective face of the abrasive wheel to a height between 0.01 mm and 1.00 mm, preferably between 0.08 mm and 0.2 mm.

9. The abrasive wheel according to claim 1, wherein each protrusion has edges, at least those connecting the protrusion to the respective face, chamfered and/or rounded.

10. A forming mold for an abrasive wheel comprising a corresponding annular forming cavity and a forming punch, wherein at least one of the annular cavity and the forming punch is provided with a respective annular forming wall, in which a plurality of cavities are recessed to allow the formation of protrusions on each face of the abrasive wheel during pressing, and the cavities have a predominantly radial development, wherein the cavities of each wall are spaced apart by reliefs configured to define respective grooves on the respective face of the abrasive wheel, wherein each cavity of the forming punch wall has a shape capable of being entirely contained within the perimeter of a respective relief of the opposing wall of the annular cavity, wherein the cavities of the forming punch wall are perfectly axially aligned with the reliefs of the opposing wall of the forming cavity, and wherein each cavity comprises lateral flanks with a curvilinear longitudinal development, preferably according to a respective monotonic convex curve.

11. The mold according to claim 10, comprising means to define and/or maintain a predetermined circumferential orientation of the forming punch wall with respect to the forming cavity wall.

12. The mold according to claim 10, wherein the cavities on one wall have a shape equal to the shape of the recesses on the opposing wall and/or the cavities on one wall have a shape equal to the shape of the recesses on the same wall.

13. The mold according to claim 10, wherein the curvilinear longitudinal development of each lateral flank of any cavity is defined by the curve according to which the tangent at any point of the curve is inclined at an angle less than 90°, preferably less than 70°, more preferably equal to 45°, with respect to the tangent of any concentric circle with the wall on which the cavity is made passing through said point.

14. The mold according to claim 13, wherein the cavities have the same orientation and/or inclination.

15. The mold according to claim 10, wherein each cavity on each wall has a cross-section of variable width and/or shape, preferably with increasing width from a proximal end to a central axis of the respective wall towards a distal end from the central axis.

16. The mold according to claim 10, wherein each cavity has a depth between 0.01 mm and 1.00 mm, preferably between 0.15 mm and 0.20 mm relative to the remaining part of the wall, preferably planar and orthogonal to a central axis of the wall, which defines the reliefs between the cavities.

17. The mold according to claim 10, wherein the cavities have chamfered and/or rounded edges at least at the edges connecting the cavities to the wall on which the cavities themselves are recessed.

18. A forming method by pressing an abrasive wheel comprising the following steps:
preparing a mixture of abrasive material grains and binder;
preparing at least one annular reinforcing mesh;
introducing the mixture and at least one annular reinforcing mesh into an annular cavity of a forming mold according to any of the preceding claims;
applying pressure to the mixture to obtain an annular body with a plurality of protrusions in relief on both faces and each having a predominantly radial development, wherein the protrusions on each face are spaced apart by grooves, wherein each protrusion on one face has a shape capable of being entirely contained within the perimeter of a respective groove on the opposite face, wherein the protrusions on one face are perfectly axially aligned with the grooves on the opposite face, and wherein each protrusion comprises lateral flanks with a curvilinear longitudinal development, preferably following a respective monotonic convex curve.

19. The method according to the preceding claim, comprising baking the annular body formed by the mold to harden and/or polymerize the binder and to obtain an abrasive wheel.
